(19) United States
(12) Patent Application Publication
(10) Pub. No.: US 2026/0180225 A1
(43) Pub. Date: Jun. 25, 2026

(54) PLUG-IN CONNECTOR ARRANGEMENT AND MATING PLUG-IN CONNECTOR

(71) Applicant: Robert Bosch GmbH, Stuttgart (DE)

(72) Inventor: Manfred Moser, Reutlingen (DE)

(21) Appl. No.: 19/124,774

(22) PCT Filed: Oct. 31, 2023
(86) PCT No.: PCT/EP2023/080356

§ 371 Date: May 21, 2025

(30) Foreign Application Priority Data
Oct. 31, 2022 (DE) 10 2022 211 543.0

(51) Int. Cl. H01R 13/11; H01R 13/187; H01R 13/41

(52) U.S. Cl. CPC H01R 13/113; H01R 13/187; H01R 13/41

(57) ABSTRACT

A plug-in connector arrangement. The plug-in connector arrangement includes a plug-in connector having a lamella cage with a plurality of contact lamellae, and a mating plug-in connector having a contact element with a head portion and a contacting part. The contact lamellae have a front portion facing the mating plug-in connector. The head portion has a collar which projects beyond the contacting part and into which a groove with an obliquely extending groove outer wall is introduced on a bottom side. In a first position of the contact element and/or of the mating plug-in connector, the groove outer wall is coupled in a first groove portion to the front portion of the contact lamellae in a first radial position.

### FIELD

The present invention relates to a plug-in connector arrangement and to a mating plug-in connector.

### BACKGROUND INFORMATION

Plug-in connector arrangements typically comprise a plug-in connector and a mating plug-in connector that can be plugged together. Plug-in connectors for high-current applications (e.g., for electrical currents of more than 10 A, preferably of more than 50 A or even more than 100 A), e.g., for electric vehicles or for automotive applications, often comprise contact elements with spring lamellae, e.g., toroidal or sleeve-shaped lamella cages, which are connected to a (e.g., shielded) cable by means of a mechanical crimp connection or by means of ultrasonic welding. In other cases, the lamella cages can also be connected, e.g., soldered or by means of a press-fit contacting, directly to a carrier element, e.g., a printed circuit board. Such plug-in connectors are designed to be connected to a mating plug-in connector, which can comprise, for example, a contacting part, e.g., in the form of a contact pin or a contact blade or the like. The plug-in connector can be plugged together with, e.g., the mating plug-in connector along an insertion direction or a plug-in direction. In a final state, a contact element of the mating plug-in connector (also referred to as a mating contact element) electrically contacts the contact element of the plug-in connector. The spring lamellae of the contact element of the plug-in connector should exhibit a normal force (or contact normal force) in the final plugged-together state, which ensures an electrical connection to the mating contact element even under mechanical and/or thermal load and across all manufacturing tolerances.

However, this normal force is usually limited, since the plug-in forces when connecting the plug-in connector to the mating plug-in connector should not exceed a defined level. In order to reduce the high insertion forces for an operator, lever designs or slider designs can be provided, e.g., so that the operating force when plugging together is reduced. However, such lever or slider designs are often complex and expensive and require a large amount of movement for operation and do not prevent damage to the surfaces rubbing against each other when the contact element of the mating plug-in connector slides along the contact lamellae. It is possible to reduce the plug-in forces by applying a friction-reducing coating to at least one contact partner (contact element and/or mating contact element) and also to reduce damage to the surfaces during the plugging process. However, this increases the cost and complexity of the production process of the corresponding contact partner and does not reliably prevent damage to the surfaces of the contact partners. In addition, as a result, under certain circumstances this can increase contact resistance in the region of the contact point.

In other applications, the contact partners (contact element and mating contact element) can be designed as, e.g., busbars. These can, e.g., be screwed together to ensure permanent contacting. When screwing with M4 screws, e.g., a so-called contact force or normal force in the range of 2000 N to 2500 N can be achieved. If M5 or M6 screws are used, even higher normal forces can be achieved. However, such a screw connection of the contact partners requires additional installation space for arranging the screws and the means to tighten or loosen the screws in the event of maintenance. In addition, multiple additional steps are necessary before and/or after the contact partners are plugged together, which makes the assembly process complex: the contact partners must be precisely aligned relative to each other in order to be able to tighten the screw, the screw must be placed in position, a tool for tightening the screw must be placed in position, the screw must be tightened, the tool must be removed.

Germany Patent Application No. DE 10 2018 202 960 A1 describes a plug-in connector for automotive applications and/or high-current applications in which the contact element is designed as a lamella cage. In order to reduce the high plug-in forces (between contact element and mating contact element) that occur for an operator during the plugging together process, a lever element is provided which is actuated during the plugging together process when the plug-in connector and mating plug-in connector are plugged together.

Germany Patent Application DE 10 2017 213 093 A1 describes a plug contact for high current applications, wherein the contact element is designed as a lamella cage and in which a high insertion force (between contact element and mating contact element) must be overcome during the insertion of a mating contact element into the contact element.

Germany Patent Application No. DE 10 2019 131 791 A1 describes a contact element of a plug-in connector, wherein the contact element is directly connected to a printed circuit board and wherein the contact element can be contacted by inserting a pin-like contact element of a mating plug-in connector.

German Patent No. DE 20 2008 005 394 U1 describes a high-current printed circuit board connector with a lamella cage, wherein the plug-in connector can be pressed into a printed circuit board by means of a plug-in base and can as a result be electrically contacted.

PCT Patent Application No. WO 2007/107 208 A1 describes a plug-in connection of the Radsok type (Radsok connector) with a socket of the Radsok type (Radsok socket) and a plug that can be plugged into the socket, which form a plug-in connector arrangement when plugged together, wherein locking means are formed on the Radsok socket and the plug which allow a defined fixing of the Radsok socket and plug.

### SUMMARY

The present invention is based on the finding that if a low normal force is present (at the contact point(s) between the contact element and the mating contact element) in the event of high temperature fluctuations and/or strong vibration or shaking loads, there is a risk that undesirable relative movements between the contact partners (contact element and mating contact element) and/or contact interruptions may occur. Furthermore, the present invention is based on the finding that for a long service life of the contacting and/or for low heating of the contact point when transmitting high currents, the largest possible contact surface between the contact partners is useful. Furthermore, the present invention is based on the finding that high insertion forces during a large portion of the path when plugging together the plug-in connector and mating plug-in connector complicate the plugging process. Furthermore, the present invention is based on the finding that the application of normal force between the contact element and the mating contact element already during the plugging process, i.e., on the path or a large part of the path, e.g., more than 30% of the path, e.g., from a pre-plugged position via an intermediate plugging position (first position) to a final plugging position (second position), not only complicates and makes the insertion process more difficult, in particular when a plurality of plug-in connectors are plugged together with a plurality of mating plug-in connectors at the same time, but can also affect the surfaces of the contact partners. If normal force is applied during the plugging process, e.g., a contact lamella can leave a grinding mark or a scratch on a contacting part to be contacted. This can undesirably damage or destroy a surface coating and can be detrimental to repeated plugging together and unplugging, since such scratches or grooves can effect the contact partner getting stuck during the plugging together or unplugging process. A high insertion force (between the contact partners) can actually reduce the number of contact partners in a plug-in connector in an undesirable way, since with a high number of contact partners the plug-in forces can become so high, even when lever or slider designs are used, that the operating force is no longer reasonable for an operator. Finally, the present invention is based on the finding that the coating of the contact partners can reduce the current carrying capacity and increase costs.

There may therefore be a need to provide a plug-in connector arrangement that allows the connection or plugging together of a plug-in connector with a mating plug-in connector (which may also be designed, e.g., as a pin header or the like) with the lowest possible plug-in force, which at the same time comprises a high normal force between the contact partners in the electrically contacted state, which comprises a high current carrying capacity, which provides the largest possible contact surface between the contact partners, which allows a permanent, safe, reliable, and uninterrupted electrical contacting between the plug-in connector and mating plug-in connector even under alternating thermal loads and/or mechanical loads such as, e.g., vibration loads or shaking loads, which requires only a small installation space or assembly space for the contacting process, which allows safe operation (no risk of contact with live parts), in which at least the contact partners (contact element and mating contact element) can be manufactured cost effectively and easily, and in which the establishment of the contacting with the desired normal force is possible in a simple manner with as few steps as possible, even in complicated installation space situations.

In the same way, there may be a need to provide a mating plug-in connector having the properties described above.

This need can be met by the features of the present invention. Advantageous example embodiments of the present invention are disclosed herein.

According to a first aspect of the present invention, a plug-in connector arrangement is proposed, in particular for high-current applications and/or high-voltage applications, in particular for automotive applications, in particular for electric vehicles (which can also include, e.g., fully or partially electrically powered aircraft, ships, boats, e-bikes, motorcycles).

According to an example embodiment of the present invention, the plug-in connector arrangement comprises a plug-in connector and a mating plug-in connector for plugging together with the plug-in connector. The insertion direction can also be referred to as the axial direction. The plug-in connector comprises a lamella cage having a base element and having a plurality of contact lamellae. The contact lamellae are connected to the base element in a rear portion. The contact lamellae protrude from the base element in the direction of the mating plug-in connector and have a front portion that faces the mating plug-in connector. The mating plug-in connector has a contact element with a head portion and a contacting part, wherein the contacting part protrudes from the head portion, wherein the head portion has a collar, which projects beyond the contacting part in a radial direction. A groove is introduced into the collar on a bottom side facing the lamella cage, wherein the groove extends at least partially obliquely outward on a groove outer wall facing an edge of the collar. The contact element and/or the mating plug-in connector is displaceable between a first position and a second position, in particular in the plugged-together state of the mating plug-in connector and the plug-in connector. In the first position, the groove outer wall is mechanically coupled in a first groove portion to the front portion of the contact lamellae in a first radial position. In the second position, the groove outer wall is mechanically coupled in a second groove portion to the front portion of the contact lamellae in a second radial position, wherein, in the second radial position, the contact lamellae are displaced along the radial direction toward the contacting part and thereby electrically contact the contacting part in a contact portion of the contacting part.

According to an example embodiment of the present invention, the groove, which may, for example, have a groove bottom and a groove inner wall in addition to the groove outer wall, advantageously ensures that the contact lamellae can be accommodated in the groove, for example with their front part or the part of the contact lamella that protrudes (with its end face) furthest from the base element in the direction of the contact element. This catching of the front portion can, for example, already take place in the first position of the contact element and/or of the mating plug-in connector. This in turn advantageously ensures that, during the (further) displacement of the contact element from the first position to the second position, the front portions of the contact lamellae are always in a defined position and the pressing process of the contact lamellae in the radial direction against the contacting part is carried out in a particularly defined and reliable manner. At the same time, tilting or jamming of the head part or of the collar when displacing from the first position to the second position is prevented, which could be caused, e.g., without the groove by individual contact lamellae whose front portion could be radially displaced, e.g., due to manufacturing tolerances, etc. The groove thus catches the front portions and then makes the correct establishment of the plug-in connection in the contact portion possible when the second position is displaced.

Furthermore, such a groove can advantageously further enlarge the additional contact surface between the contact lamellae and the contact element. This is because, by displacing the contact element to the second position, the part of the front portion caught in the groove can ultimately only expand in the radial direction in the groove since the axial space available to the contact lamella is shortened. This applies particularly if the contact lamella is mechanically contacted and compressed in its front region by the groove bottom. This expansion in the groove leads to a larger filling of the groove with parts or with material of the contact lamella and thus to a larger contact surface. Furthermore, by filling the groove more with material of the contact lamella, a force of the contact lamella in the groove on the groove walls and the groove bottom is also increased, which increases the contact normal force of the contact lamella to the boundary surfaces of the groove (groove walls and groove bottom). As a result, additional contact paths are advantageously effected in the groove, which increases the redundancy of the contact points, reduces contact resistance and advantageously increases the reliability and service life of the plug-in connector arrangement and in particular of the contact point.

The obliquely extending groove outer wall advantageously creates a type of slot guide, through which the contact lamellae are moved or displaced in a targeted manner in the radial direction toward the contacting part. In this way, the displacement can be influenced in a targeted or more targeted manner. Furthermore, the shape of the slope can advantageously form a type of path-force curve, by means of which the translation of the axial path of the contact element into a radial path of the contact lamellae can be adjusted when the contact element is displaced from the first position to the second position. By adjusting the slope, the application of the normal force can be advantageously adapted to the specified installation space situation and to the available path from the first position to the second position.

The mechanical coupling of the groove outer wall and the second groove portion in the second position advantageously further increases a contact surface between the contact lamellae and the contact element. This is because not only the contact lamellae are then in (radial) contact with the contacting part (with an inner side of the contact lamellae). The contact lamellae also contact the head portion, in particular in a very defined manner at a very defined point, namely in the groove, on the groove outer wall. And thus on the outer side of the contact lamellae. This advantageously increases the number of contact points between the lamella cage and the contact element, reduces the contact resistance, and improves the robustness against vibrations, thermal loads, and manufacturing tolerances.

Furthermore, it is advantageous that the joining or plugging together of the plug-in connector and mating plug-in connector can be effected in a largely force-free manner or with a very low insertion force and the actual application of the contact element of the mating plug-in connector with the contact normal force is only carried out at the end of the plugging process. In contrast to conventional lamella cages, in which the insertion process of the contact element of the mating plug-in connector must already widen the contact lamellae radially outward in the region of the contact lamellae (the so-called “snap peak” in the insertion force) and the frictional force between the contact lamellae and the contact element must also be overcome on the further path, an increased force, which is necessary so that the contact lamellae can apply the contact normal force to the contact element, is only to be applied at the end of the insertion process or the joining process. This force along the insertion direction only needs to be applied from the first position to the second position but not along the insertion path up to the first position. This advantageously simplifies the assembly process, advantageously makes larger manufacturing tolerances possible since jamming due to the insertion forces is prevented, and advantageously also allows correction of the arrangement of the plug-in connector and mating plug-in connector during the assembly process. Furthermore, the joining process and/or plugging process in a manufacturing line can also be advantageously distributed across different, spatially separated machines or workstations: In a first step, the plug-in connector and the mating plug-in connector and/or the contact element and lamella cage are, for example, simply plugged or joined together until the first position is reached. This is done substantially in a force-free manner or with very little insertion force. In this first position, the contact lamellae and the contacting part advantageously already overlap. In a second step (which can also be carried out at another workstation or by other machines or technicians), the application of the contact normal force can then be carried out, and thus the formation of the desired electrical (and also mechanical) connection can be carried out. In this way, pre-assembly is possible. It may also be possible, e.g., that the pre-assembly process (reaching the first position) is secured, e.g., mechanically, e.g., by a type of primary locking, so that the pre-assembled plug-in connector arrangement can be transported to another location without problems and without loss.

In addition, as a result, it is advantageously prevented that the surfaces of the contact element and the contact lamellae are damaged or destroyed during the joining process along a longer path (e.g., from the beginning of the overlap of the contact lamella contact point and the contacting part of the contact element up to the contact portion of the contacting part). As a result, a repeated plugging together and unplugging of the plug-in connector and mating plug-in connector (e.g., for repairs, maintenance, etc.) is allowed, as a result of which the sustainability of the plug-in connector arrangement and the associated components is advantageously improved.

Furthermore, according to an example embodiment of the present invention, it is advantageously possible to increase the number of contact lamellae in comparison to conventional plug-in connector arrangements and/or to increase the applied normal force of the contact lamellae in the final plugging position. According to an example embodiment of the present invention, alternatively or additionally, a material can be used for the contact lamellae which comprises a higher spring constant or a higher modulus of elasticity. As a result, an improved current carrying capacity can be achieved over the lifetime, the thermal load on the contact partners in the contact region can be advantageously reduced (lower contact resistance) and the plug-in connector arrangement can as a result exhibit increased robustness, e.g., against alternating thermal loads, vibrations and/or manufacturing tolerances. Since an increased axial force only needs to be applied at the end of the plugging process (on the (in particular short) path from the first position to the second position) in order to apply a radially acting contact normal force, an actuating element, for example, can be arranged on the plug-in connector and/or on the mating plug-in connector which actuating element has a particularly high force transmission (e.g., more than 10:1 or more than 50:1, or more than 100:1) despite a possibly limited operating path. In cases where there is little installation space and little space for the movement of such an actuating element, the proposed invention can ensure that a significant force transmission is possible using simple means. Such an operating element or actuating element—which can be provided optionally, but is not absolutely necessary and thus not essential—can be designed, e.g., as a lever or a slider. Such an actuating element can be arranged, e.g., on a plug-in connector housing or on a mating plug-in connector housing. It can, e.g., comprise a slot structure which interacts with a complementary pin or bolt on the mating element (if the actuating element is arranged, e.g., on the plug-in connector or connector housing, then the bolt or pin can be arranged on the mating plug-in connector or mating plug-in connector housing).

Furthermore, according to an example embodiment of the present invention, the mechanical contact or the mechanical coupling of the second groove portion with the front portion of the contact lamellae in the second position advantageously increases the number of the contact points between the contact element and the lamella cage. For example, the number of contact points can be at least doubled in comparison to a situation in which only the contacting part is in mechanical and electrical contact with the contact lamellae. This advantageously increases the current carrying capacity, reduces the electrical contact resistance, increases the redundancy of the contact points, reduces the thermal load on the contact point(s), and also further improves the robustness against (radial) manufacturing tolerances and against (radial) vibrations and/or shaking loads.

The insertion direction can, e.g., be given as the direction along which the mating plug-in connector is plugged together with the plug-in connector. It can preferably be defined, e.g., as the direction along which the contact element is displaced relative to the lamella cage in order to effect the contacting. The insertion direction can also be referred to as the axial direction.

The radial direction runs, e.g., perpendicular to the insertion direction. One circumferential direction runs around, e.g., the insertion direction.

According to an example embodiment of the present invention, The groove can be arranged, for example, between the contacting part and an edge of the collar.

The first radial position can, for example, be an outer radial position. For example, it can be spaced further apart from the contacting element along the radial direction than the second radial position. The second radial position can, for example, be an inner radial position that is closer to the contacting element than the first radial position.

In the first position, for example, a radial play can be formed between the contact lamellae and the contacting part of the mating plug-in connector. This advantageously supports or makes possible a (virtually) force-free joining process or insertion process or plugging-together process at least up to the first position.

A distance (referred to below as the third distance) may be formed between the first radial position and the second radial position. This distance can, for example, be greater than the radial play between the contact lamellae and the contacting part in the first position. It can, for example, be at least 5%, preferably at least 10% greater than this radial play.

The groove can, e.g., be designed to be circumferential. The groove can, for example, run around the contacting part along the circumferential direction. It can, for example, be designed to be closed, e.g., closed in a ring shape. For example, it can have a uniform cross-section along its extent.

In particular, according to an example embodiment of the present invention, the groove can extend obliquely on the groove outer wall in such a way that a type of half-funnel shape can be seen when looking into the groove.

The groove outer wall can, for example, be oblique over most of its extent, e.g., along at least 80% or even at least 90% of its extent. The extent of the groove outer wall can, for example, run from the edge to the groove bottom. As a result, the groove can be produced particularly simply.

According to an example embodiment of the present invention, the gradient of the slope can be constant, in the manner of a straight line. However, the groove outer wall can be a curved slope in the manner of a concave or convex shape. This advantageously allows the plug-in forces on the way from the first position to the second position to be set up in a defined manner. This can also make it easier to catch the contact lamellae.

The groove outer side can, for example, have two or more groove portions that have different gradients. There can be a continuous or abrupt transition from one gradient to the next between the groove portions. The groove can, for example, have a vertical groove outer wall (parallel to the insertion direction) in the second groove portion or can even have a slope that extends away from the contacting part (in the direction of an upper side of the collar) so that an undercut is formed in the collar. This has the advantageous effect that the plug-in connector arrangement is self-stabilized in the second position. This is because, e.g., due to their elasticity, the contact lamellae then cannot exert a radial force on a slope that pushes the contact element from the second position in the direction of the first position. If an undercut is formed in the second position, to release the contact element from the second position, it would be necessary to exert even a slightly increased release force initially in order to displace the contact lamellae from the undercut.

According to an example embodiment of the present invention, the lamella cage can, e.g., be configured such that the contact element, in particular with its contacting part, can be inserted into an interior of the lamella cage. The base element of the lamella cage can, for example, also be referred to as a collar or, e.g., be designed as a collar to which the contact lamellae are attached. The base element and the contact lamellae can be manufactured, e.g., in one piece, e.g., from a single piece of sheet metal. They can be designed, e.g., as stamped and bent parts. The contact lamellae can, for example, be configured to contact the contacting part, in particular to contact it electrically.

According to an example embodiment of the present invention, the contact lamellae can, for example, be attached in the front portion to a further base element or head element or a further collar so that they run between the two base elements or between the base element and the head element. The contact lamellae can thus be connected to one another in the front portion, e.g., by means of the head element. However, it can also be provided that the contact lamellae have a self-supporting or free end in the front portion, for example, or are self-supporting in the front portion. It can be provided, e.g., that the contact lamellae in the front portion are not connected to each other. Such a free end can, e.g., point directly in the direction of the mating plug-in connector and thus represent a type of end face of the contact lamella in the direction of the contact element. However, there may also be embodiments in which the contact lamellae are bent at or with their free end and point, for example, in a radial direction or even in the direction of the base element. In such a case, a part of the front portion forms the end face that protrudes furthest from the base element in the direction of the contact element.

According to an example embodiment of the present invention, the contacting part can, for example, protrude from the head portion of the contact element along the insertion direction. The contacting part can be designed, for example, as a pin or as a contact blade, in general: as a male contacting part. The contact element can, for example, have a mushroom shape, wherein the contacting part represents the stem and the head portion represents the cap of the mushroom. In a longitudinal section, the contact element can, for example, have a T shape. For example, it may protrude at least 2 mm from the head portion, preferably at least 5 mm and particularly preferably at least 10 mm.

The displacement between the first position and the second position can be carried out, e.g., along the insertion direction. The first position can, for example, be an intermediate plugging position, in which a large part (e.g., more than 70%, preferably more than 90%) of the plug-in path between the contacting part and the contact element has already been covered. Only by way of example, the plug-in path can be described as the path on which the contacting part overlaps with the contact element, viewed in the radial direction. The second position can be, e.g., a final plugging position.

In the first position, e.g., a gap can be formed between the contacting part and the contact lamellae (with simultaneous overlap of the contacting part and the contact lamellae). This gap can, for example, allow for radial play between the contacting part or the contact lamellae.

In the second position, the contact lamellae can clamp the contacting part between them, for example. The clamping can be formed, e.g., along the radial direction. The term “clamping” here is understood to mean that the contacting part is held captively between or by the contact lamellae, assuming that the contact lamellae are held in the second radial position, e.g., by the second groove portion of the groove outer wall. The contacting part is thus clamped or firmly clamped between the contact lamellae when viewed along the radial direction. In other words, in the second position, the contacting part has an oversized dimension with respect to the contact lamellae with respect to the space delimited by the contact lamellae (in the case of only two contact lamellae, which would be approximately opposite each other, the oversized dimension could be formed, e.g., with respect to the distance between the contact lamellae).

For example, it can be provided that the contact lamellae enclose a contacting space. The contact lamellae can be arranged around the contacting space, for example only viewed along the circumferential direction. The contacting part can be located in the second position with the contact portion in the contacting space and can be contacted there (in the contacting space) by the contact lamellae.

In other words, the contacting space can be formed, e.g., radially inside between the contact lamellae. It can, for example, be part of an interior of the lamella cage. The contacting part of the contact element can, for example, be inserted into the contacting space in the first position and in the second position. The contacting space can have an oversized dimension (in particular along the radial direction) with respect to the contacting part, e.g., in the not fully plugged-together state (i.e., during the insertion process or joining process up to the first position). In the fully plugged-together state, in particular in the second position, the contacting part can, e.g., have an oversized dimension (in particular along the radial direction) in comparison to the contacting space.

The contact lamellae can be, e.g., designed to be elastically reversible. This means that, when the contact element returns from the second position to the first position, the contact lamellae are displaced back to their initial position (i.e., they are displaced radially away from the contacting part). As a result, an unplugging process can also advantageously be carried out without requiring a greater unplugging force and/or without damaging the surfaces of the contact partners. In addition, a new plugging process or joining process is then made possible, preferably at least up to the first position (approximately), in a force-free manner or with play between the contact lamellae and the contacting part.

The contact element can, e.g., be designed in one piece. For example, the contacting part and the head portion can be designed so that they cannot be separated from each other in a non-destructive manner. It can be provided, e.g., that the head portion and the contacting part are rigidly connected to each other, in particular cannot be displaced relative to each other. Alternatively, it can be provided that the contacting part can be displaced relative to the head portion, e.g., along the axis of the contacting part. For example, the contacting part can be movable through an opening in the head portion. The contacting part and the head portion can be made, e.g., of an electrically conductive material, e.g., the same material. In an alternative embodiment, the head portion and/or the collar can be formed, for example, from a different material to the contacting part, for example from an insulating material, wherein the head portion and/or the collar is designed or configured or serves only to apply the axial force to the front portion of the contact lamellae during the displacement from the first position to the second position.

The contacting part can be designed, for example, as a pin or as a contact blade or the like. For example, it can generally be designed as a male contact part that can be inserted into the lamella cage as a female contact part.

The contacting part can have, e.g., a diameter in the range between 2 mm and 30 mm, preferably between 4 mm and 20 mm.

A single lamella or contact lamella can, e.g., have a thickness in the range of 200 um (200 micrometers) to 3 mm, preferably between 400 um and 2 mm. A lamella width or a width of a contact lamella can, e.g., be greater than the thickness of the contact lamella.

It can be provided, e.g., that the diameter of the lamella cage is at least 20 um larger than a diameter of the contacting part, preferably at least 50 um.

The term “comprise” is used synonymously with the term “have”, unless otherwise stated.

In a development of the present invention, it is provided that, in the second position, the contact lamellae contact the contact portion with a contact normal force in the radial direction of at least 1 N, preferably of at least 5 N. For example, the contact normal force of the contact lamellae, in particular of each contact lamella or the majority of contact lamellae, is in a range between 5 N and 50 N or even between 5 N and 200 N. As a result, a particularly safe and reliable contacting, which has a low contact resistance over its service life, even in the event of vibrations, alternating thermal loads or other operating conditions, is advantageously effected. As a result, heating at the transition between the contact partners can advantageously be kept to a minimum, even at high currents of, e.g., more than 50 A or even more than 100 A. Furthermore, this can advantageously reduce the installation space, weight, and material usage in the contact zone, in particular at the lamella cage, since reliable contacting by means of high contact normal force makes a smaller number of contact points possible. Furthermore, as a result the service life of the plug-in connector arrangement is advantageously increased.

In a development of the present invention, it is provided that the base element of the lamella cage is designed to be circumferentially closed. As a result, it is advantageously effected that the lamella cage is designed to be particularly stable and in the second position the contact lamellae cannot spread the base element apart. This advantageously results in a particularly reliable and permanent application of the contact normal force.

For example, it can be provided that the base element or the collar or the collar region of the lamella cage is designed to be closed in a ring shape.

The base region can have a circular or elliptical cross-section, e.g., in the force-free state (i.e., before mounting the mating plug-in connector). In principle, however, a polygonal, e.g., triangular, quadrangular, pentagonal, hexagonal, heptagonal, octagonal cross-section of the base element is also possible. Even more than eight corners are possible.

The circumferentially closed shape can be achieved, e.g., by rolling up an originally flat stamped and bent part, e.g., made of a metal sheet. In order to keep the base region closed, a material-bonded connection (e.g., by a welding process or an adhesive process or a soldering process) can be provided, for example. However, a form-fitting connection can also be provided; e.g., at least one type of eyelet or one type of recess with a neck region with a flat or narrow neck can be formed at one end of the base region and at least one type of pin with a shape complementary to the eyelet or the recess can be formed at the other end of the base region (tongue-and-groove principle). After the stamped and bent part has been rolled up, the at least one pin can then be inserted into the complementary at least one assigned eyelet or recess so that the base element cannot unroll again. A form-fitting connection makes it possible to achieve a particularly simple and cost-effective assembly and temperature-stable connection.

In a development of the present invention, it is provided that the first position and the second position are spaced apart along the insertion direction by a maximum of 5 mm, preferably by a maximum of 2 mm, and particularly preferably by a maximum of 1 mm. This has the advantageous effect that the contact partners (contact lamellae and contacting part) can only rub against each other along a very short, in particular axial, distance and that damage to the surfaces is thereby prevented or limited to a very short path range. Furthermore, as a result a plug-in connector arrangement that requires only an extremely small installation space along the insertion direction can be advantageously provided. Finally, a particularly high normal force can advantageously be applied in this way if, e.g., an actuating element is provided for reducing the operating force. For example, if the distance between the first position and the second position is 1 mm and the path of an optional actuating element, such as, e.g., a slider element or a rotatably mounted lever element, is 100 mm, then a force transmission of 100:1 can be achieved. The entire path of the actuating element and thus the entire force transmission can be used to apply the contact normal force as a result. There is no need to waste part of the actuation path for part of the joining path. Furthermore, e.g., the force transmission can advantageously be designed to be highly uniform along the actuation path, e.g., by means of a substantially linear slot profile having a uniform gradient in the actuating element. This is because an optional actuating element only needs to be used for the distance from the first position to the second position and not for the entire joining path. Alternatively, the actuation path can be reduced with the same force transmission, as a result of which installation space or free space can be saved for the actuation of the actuating element.

In a development of the present invention, it is provided that, in the first position, the radial play between the contact lamellae and the contacting part is in a range between 5 um (5 micrometers) and 200 um (200 micrometers) or in a range between 20 um and 100 um. As a result, it is advantageously effected that a high contact normal force can be formed even with a short distance between the first position and the second position. Furthermore, as a result a high force transmission can be achieved, since only a very small radial path has to be covered for the contacting or only a very small gap has to be closed. For example, if an axial path of 1 mm is available between the first and second positions and the gap or radial play is uniformly 100 um all around, a force transmission of 10:1 can already be achieved. At the same time, such a small radial play already advantageously allows the insertion process or joining process to be carried out in an almost force-free manner, e.g., at least up to the first position. Such a small play also allows a particularly compact design of the lamella cage and/or the plug-in connector in the radial direction.

In a development of the present invention, it is provided that the contact lamellae extend at least partially obliquely from the base element toward the contacting part or run obliquely toward the contacting part or contact element or protrude obliquely from the base element toward the contacting element. This has the advantageous effect that the contact lamellae are already arranged closer to the contacting part in the first position, i.e., that the radial play or gap can be smaller than if the contact lamellae were to run straight upward (i.e., in parallel with the insertion direction) or obliquely radially away from the contacting part. Furthermore, it is advantageously possible to arrange the base element radially further away from the contacting part, whereby the contacting part can advantageously pass the base element in the plugged-together state and does not collide with it (a greater insertion depth can thus be achieved). The contacting part can be inserted, for example, into a guide element (e.g., an opening with only a slightly larger diameter) and/or a locking element (viewed along the insertion direction) below the base element and thus better define or stabilize the alignment of the contacting part. Furthermore, the displacement of the contact lamellae radially toward the contacting part can advantageously be carried out more easily and reliably since the contact lamellae already have a preferred direction radially toward the contacting element in the force-free state.

If the lamella cage in its interior encloses a contacting space into which the contact element or its contacting part is inserted, it can be provided that the contact lamellae at least partially extend obliquely radially inward or protrude obliquely radially inward or run obliquely radially inward from the base element.

In a development of the present invention, it is provided that the plug-in connector has a contact chamber with an outer wall, wherein the lamella cage is arranged in the contact chamber, wherein the base element is arranged in the interior of the contact chamber adjacent to the outer wall.

This has the advantageous effect that the lamella cage can be mounted particularly easily and reliably in or on the plug-in connector. It can be inserted or pushed, e.g., into the contact chamber. As a result, it is automatically arranged in the correct position in the plug-in connector. Furthermore, this advantageously makes it possible to form a particularly large electrical transition area from the lamella cage to the plug-in connector, which reduces the contact resistance. For example, the contact chamber can be designed to be electrically conductive and can be electrically contacted with the base element at least in the second position, e.g., from the outer side of the base element to the inner side of the outer wall of the contact chamber. Furthermore, as a result, a complex press-in mounting, e.g., into a printed circuit board or a soldering or welding of the lamella cage, e.g., to a carrier substrate or an electrical component, can be dispensable.

According to an example embodiment of the present invention, it can be provided, e.g., that the outer wall of the contact chamber in the force-free state of the lamella cage rests on the base element or is spaced apart from the base element only by a (radial) gap, e.g., by a gap of at most 500 um, preferably of at most 200 um, and particularly preferably of at most 100 um. In this way, the lamella cage is on the one hand still easy to insert into the contact chamber, ideally in a force-free manner, but at the same time it is positioned very precisely with respect to the radial direction, which ensures a simple and reliable joining process with the mating plug-in connector.

In a development of the present invention, it is provided that the base element is supported on the outer wall of the contact chamber in the second position. This has the advantageous effect that the radial displacement of the contact lamellae toward the contacting part as a result of the coupling with the groove outer wall on the way from the first position to the second position does not lead to an (excessive) spreading apart of the base element and/or the contact lamellae being displaced in the axial direction instead of in the radial direction (during the transition from the first position to the second position). Advantageously, as a result, a material thickness of the base element can also be reduced or a material with a lower modulus of elasticity can be used, which can result in cost advantages.

Furthermore, this advantageously improves electrical contacting between the base element and the contact chamber in the second position since the base element forms a secure mechanical and electrical contact with the contact chamber by being supported on the outer wall.

The support can be provided, for example, in the radial direction.

For example, a radial movement of the base element (e.g., when displacing the contact element from the first position to the second position) can be limited by the outer wall of the contact chamber to less than 500 um, preferably to less than 200 um, and particularly preferably to less than 100 um.

In a development of the present invention, it is provided that a groove inner wall is flush with a contacting part outer wall. This advantageously catches the contact lamellae particularly close to the contacting part (when viewed in the radial direction). Furthermore, this can advantageously generate a particularly high contact pressure or a particularly high contact normal force of the contact lamellae on the contacting part. Furthermore, this advantageously avoids the contact lamellae having to overcome a step between the contacting part and the groove inner wall, and the surface of the contact lamellae is thus particularly well protected against scratches or other damage.

In a development of the present invention, a first angle of the groove inner wall with respect to the insertion direction is in a range between 2° and 45° or in a range between 3° and 15°. This advantageously achieves a particularly high force transmission by means of the slope of the groove outer wall. In this case, the displacement distance of the contact lamellae in the radial direction toward the contacting part is at most as large as the axial distance from the first position to the second position. This makes it possible to reduce the operating force even when high contact forces are to be generated. This advantageously results in a force transmission that makes an actuating element for reducing the plug-in force superfluous or supplements it and enhances its effect.

In a development of the present invention, it is provided that the contact lamellae contact the groove on at least two sides. This advantageously results in a further increase in the contact surface or the contact points. As a result, robustness against adverse operating conditions is increased and contact resistance is reduced. As already described above, the groove has three surfaces or sides: a groove inner wall or groove inner side (in the direction of the contacting part), a groove outer wall or groove outer side (in the direction of the edge of the head portion) and a groove bottom or a bottom side. The groove bottom can, e.g., extend transversely to the insertion direction.

According to an example embodiment of the present invention, it can be provided, e.g., that the surfaces or sides of the groove contacted by the front portion are rotated at least 30° relative to each other. In the second position, for example, the groove bottom and the groove inner wall can thus be contacted by the front portion of the contact lamella, or the groove bottom and the groove outer wall or all three walls can be contacted by the front portion.

In a development of the present invention, it is provided that the contact lamellae in the front portion are bent in the radial direction away from the contacting part.

This advantageously provides a type of insertion funnel for the contacting part, which simplifies the joining process of the contact element into the lamella cage and makes the joining process possible without damaging the front portion, even with manufacturing tolerances. At the same time, this also simplifies the radial displacement of the contact lamellae during the transition from the first to the second position since the collar can mechanically contact a defined support surface. Furthermore, this advantageously makes improved force application from the groove outer wall into the contact lamella along the radial direction possible. The contact normal force or a contact pressure of the contact lamellae in the contact portion of the contacting part can thereby be improved or increased.

For example, it can be provided that the bend is formed relative to the insertion direction by a second angle of at least 30°, preferably of at least 60°, and particularly preferably of at least 110°. Even a bend by more than 180° is possible. In this case, the free end can point toward the contact lamellae again.

The contact lamellae can be bent, for example, radially outward in the front portion or with the free end. For example, they can be bent outward or away from the contacting part beyond the cross-section of the base element.

In a development of the present invention, it is provided that the mating plug-in connector can be displaced from a pre-plugged position, in which the contacting part does not yet overlap with the contact lamellae, at least up to the first position with a force of less than 5 N, in particular in a force-free manner, along the insertion direction.

This has the advantageous effect that the joining or plugging together of the plug-in connector and mating plug-in connector can be effected in a largely force-free manner or with a very low insertion force and the actual application of the contact element of the mating plug-in connector with the contact normal force is only carried out at the end of the plugging process. In contrast to conventional lamella cages, in which the insertion process of the contact element of the mating plug-in connector must already widen the contact lamellae radially outward in the region of the contact lamellae (the so-called “snap peak” in the insertion force) and the frictional force between the contact lamellae and the contact element must also be overcome on the further path, an increased force, which is necessary so that the contact lamellae can apply the contact normal force to the contact element, is only to be applied according to the present invention at the end of the insertion process or the joining process. This advantageously simplifies the assembly process, advantageously makes larger manufacturing tolerances possible since jamming due to the insertion forces is prevented, and advantageously also allows correction of the arrangement of the plug-in connector and mating plug-in connector during the assembly process. Furthermore, the joining and/or plugging process in a manufacturing line can also be advantageously distributed across different, spatially separated machines or workstations: in a first step, the plug-in connectors and mating plug-in connectors are, e.g., simply plugged or joined together until the first position is reached. This is done substantially in a force-free manner or with very little insertion force. In this first position, the contact lamellae and the contacting part advantageously already overlap. In a second step (which can also be carried out at another workstation or by other machines or technicians), the application of the contact normal force can then be carried out, and thus the formation of the desired electrical (and also mechanical) connection can be carried out. In this way, pre-assembly is possible. It may also be possible, e.g., that the pre-assembly process (reaching the first position) is secured, e.g., mechanically, e.g., by a type of primary locking, so that the pre-assembled plug-in connector arrangement can be transported to another location without problems and without loss.

In addition, as a result, it is advantageously prevented that the surfaces of a the contact element and the contact lamellae are damaged or destroyed during the joining process along a longer path (e.g., from the beginning of the overlap of the contact lamella contact point and the contacting part of the contact element up to the contact portion of the contacting part). As a result, a repeated plugging together and unplugging of the plug-in connector and mating plug-in connector (e.g., for repairs, maintenance, etc.) is allowed, as a result of which the sustainability of the plug-in connector arrangement and the associated components is advantageously improved.

Furthermore, according to an example embodiment of the present invention, it is advantageously possible to increase the number of contact lamellae in comparison to conventional plug-in connector arrangements and/or to increase the applied normal force of the contact lamellae in the final plugging position. Alternatively or additionally, a material can be used for the contact lamellae which comprises a higher spring constant or a higher modulus of elasticity. As a result, an improved current carrying capacity can be achieved over the lifetime, the thermal load on the contact partners in the contact region can be advantageously reduced (lower contact resistance) and the plug-in connector arrangement can as a result exhibit increased robustness, e.g., against alternating thermal loads, vibrations and/or manufacturing tolerances. Since an increased axial force only needs to be applied according to the present invention at the end of the plugging process (on the (in particular short) path from the first position to the second position) in order to apply a radially acting contact normal force, an actuating element can be arranged on the plug-in connector and/or on the mating plug-in connector, for example, which actuating element has a particularly high force transmission (e.g., more than 10:1 or more than 50:1, or more than 100:1) despite a possibly limited operating path. In cases where there is little installation space and little space for the movement of such an actuating element, the proposed invention can ensure that a significant force transmission is possible using simple means. Such an operating element or actuating element—which can be provided optionally, but is not absolutely necessary and thus not essential—can be designed, e.g., as a lever or a slider. Such an actuating element can be arranged, e.g., on a plug-in connector housing or on a mating plug-in connector housing. It can, e.g., comprise a slot structure which interacts with a complementary pin or bolt on the mating element (if the actuating element is arranged, e.g., on the plug-in connector or connector housing, then the bolt or pin can be arranged on the mating plug-in connector or mating plug-in connector housing).

The term “force-free” is to be understood in such a way that the joining or plugging together of the plug-in connector and mating plug-in connector, at least up to the first position, requires only an insignificant amount of force or an insignificant amount of mating force, and in particular no snap peak for pushing apart contact lamellae or a friction force between the contact partners has to be overcome. In particular in the case of power contacts for high-current or high-voltage applications, a joining force or mating force of less than 10 N, preferably less than 5 N and particularly preferably less than 3 N can be considered “force-free.”

In a development of the present invention, it is provided that, in the second position, a groove bottom mechanically contacts the front portion of the contact lamellae in such a way that the contact lamellae are displaced along the radial direction toward the contacting part and, as a result, the contact lamellae exert an additional contact normal force in the radial direction on the contact portion of the contacting part.

In other words, through the mechanical contacting of the front portion of the contact lamella by means of the groove bottom, an, in particular axial, force is exerted by the groove bottom on the corresponding contact lamella. The contact lamella is thereby compressed in the axial direction, whereby it deflects in the radial direction toward the contacting part and thus increases the contact normal force.

The mechanical contact of the groove bottom with the front portion of the contact lamellae advantageously increases the number of contact points between the contact element and the lamella cage (even further). In comparison to a situation in which only the contacting part is in mechanical and electrical contact with the contact lamellae or to the situation in which the front portion of the contact lamellae is also in mechanical and electrical contact with the second groove portion, the number of contact points is increased even further. This advantageously increases the current carrying capacity, reduces the electrical contact resistance, increases the redundancy of the contact points, reduces the thermal load on the contact point(s), and also further improves the robustness against (radial) manufacturing tolerances and against (radial) vibrations and/or shaking loads. This is because the contacts between the groove bottom and the front portion of the contact lamellae are formed along the axial direction and are thus orthogonal to the contact points between the contact lamellae and the contacting part, which contact points preferably act or are formed in the radial direction. Furthermore, the contact normal force exerted by the contact lamellae on the contact portion is advantageously further increased, which improves the robustness of the plug-in connector arrangement. Furthermore, this axial mechanical contacting can also advantageously compensate for manufacturing tolerances, e.g., of the groove. In the event that the radial guidance of the contact lamellae through the groove would not be sufficient to cause a sufficiently large radial displacement of the contact lamellae, the axial force application can compensate for such a deficit.

According to an example embodiment of the present invention, it can be provided, for example, in particular in the case of contact lamellae arranged opposite one another, that the groove bottom mechanically contacts the contact lamellae in their front portion in such a way that the contact lamellae are displaced radially inward on the path of the contact element from the first position to the second position and an additional contact normal force is thereby exerted on the contacting part in the contact portion. In the second position, the contact lamellae are then displaced radially inward and contact the contacting part in the contact portion.

In the second position, the groove bottom can, for example, be in axial contact with the front portion of the contact lamellae and thus exert an axial force on the contact lamellae, which leads to the at least partial displacement of the contact lamellae in the radial direction toward the contacting part. In the second position, the groove bottom can be pressed onto the front portion of the contact lamellae, in particular along the axial direction.

According to an example embodiment of the present invention, it can be provided, for example, in particular in the case of contact lamellae arranged opposite one another, that the groove bottom mechanically contacts the contact lamellae in their front portion in such a way that the contact lamellae are displaced radially inward on the path of the contact element from the first position to the second position and an additional contact normal force is thereby exerted on the contacting part in the contact portion. In the second position, the contact lamellae are then displaced radially inward and exert an additional contact normal force on the contacting part in the contact portion.

On the path from the first position to the second position and in the second position, the groove bottom can, for example, be in axial contact with the front portion of the contact lamellae and thus exert an axial force on the contact lamellae, which leads to the at least partial displacement of the contact lamellae in the radial direction toward the contacting part. In the second position, the groove bottom can be pressed onto the front portion of the contact lamellae, in particular along the axial direction.

According to a further aspect of the present invention, a mating plug-in connector, in particular for high-current applications and/or high-voltage applications, is provided.

According to an example embodiment of the present invention, the mating plug-in connector is suitable or configured for being plugged together with a plug-in connector having a lamella cage with a plurality of contact lamellae. The mating plug-in connector has a contact element with a head portion and a contacting part, wherein the contacting part protrudes from the head portion, wherein the head portion has a collar, which projects in a radial direction beyond the contacting part, wherein a groove is introduced into the collar on a bottom side facing the lamella cage, wherein the groove runs at least partially obliquely outward on a groove outer wall facing an edge of the collar, wherein the contact element and/or the mating plug-in connector, in particular in the plugged-together state with the plug-in connector, is displaceable between a first position and a second position, in particular along the insertion direction, wherein the groove outer wall is configured in the first position to mechanically couple in a first groove portion to the front portion of the contact lamellae in a first radial position, wherein the groove outer wall is configured in the second position to mechanically couple in a second groove portion to the front portion of the contact lamellae in a second radial position, wherein, in the second radial position, the contact lamellae are displaced along the radial direction toward the contacting part and thereby electrically contact the contacting part in a contact portion of the contacting part and in particular clamp the contacting part between them.

This advantageously provides a mating plug-in connector which makes possible a (virtually) force-free joining process over a large distance of the insertion process and, at the same time, facilitates the defined application of a contact normal force on the way from the first position to the second position. The other advantages described above also apply to the proposed mating plug-in connector.

### BRIEF DESCRIPTION OF THE DRAWINGS

Further features and advantages of the present invention will become apparent to a person skilled in the art from the following description of exemplary embodiments, which, however, are not to be interpreted as limiting the present invention, with reference to the figures.

### BRIEF DESCRIPTION OF THE DRAWINGS

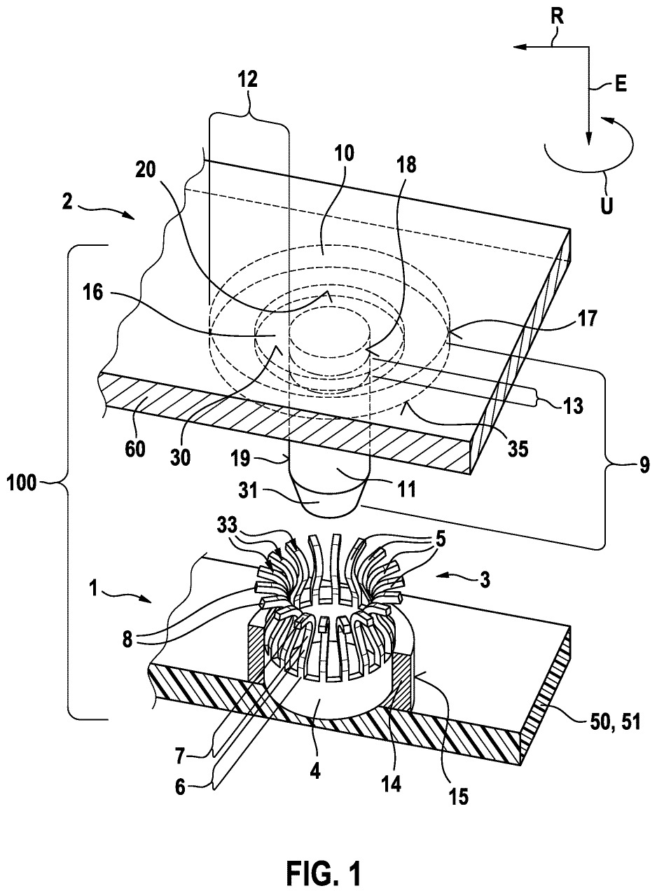

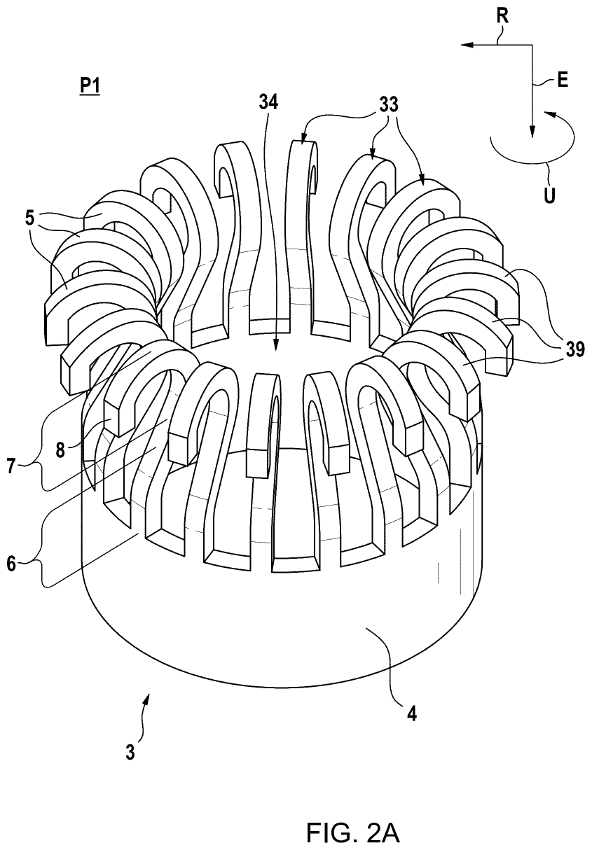

FIG. 1 is a schematic perspective view of a plug-in connector arrangement in a non-contacted state, according to an example embodiment of the present invention.

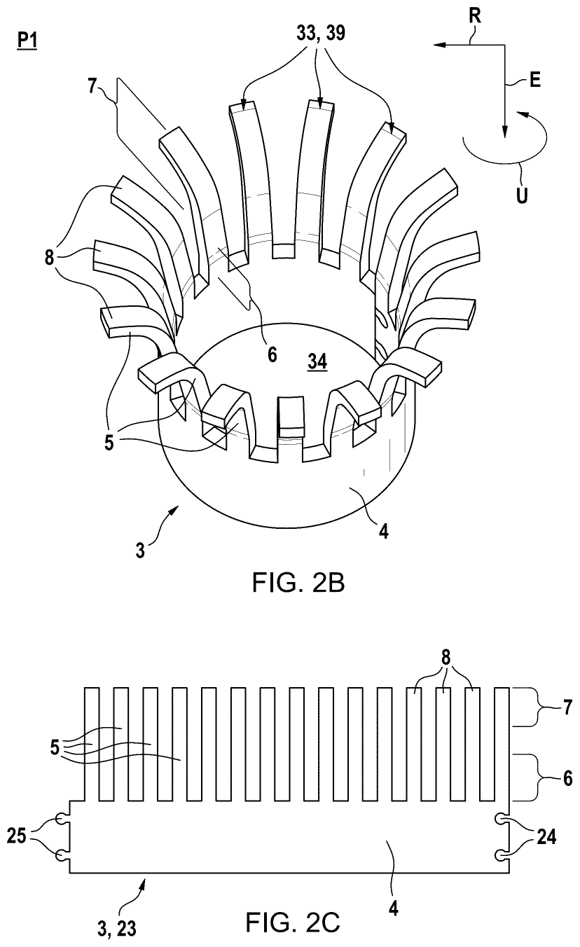

FIG. 2A to 2C are perspective schematic views of two different lamella cages of a plug-in connector (FIGS. 2A and 2B) along with a top view of a stamped sheet (FIG. 2C) as the initial state for a lamella cage, according to example embodiments of the present invention.

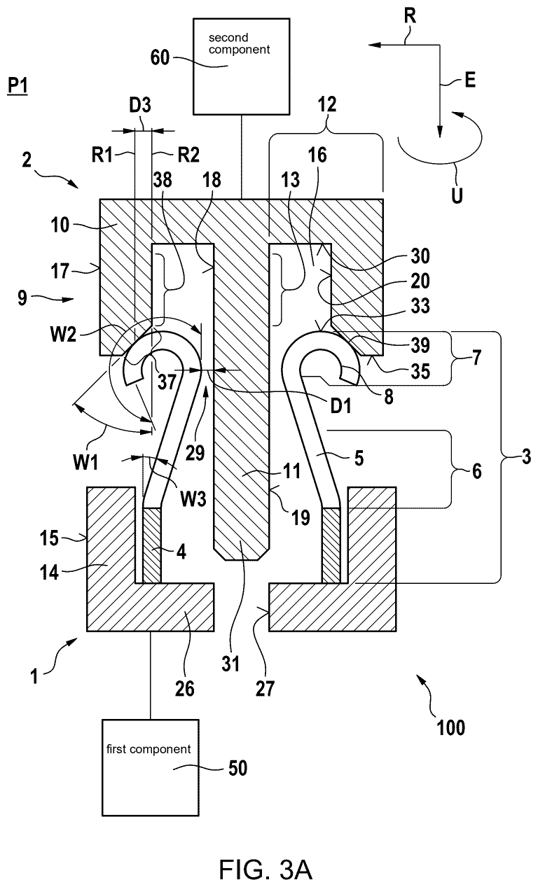

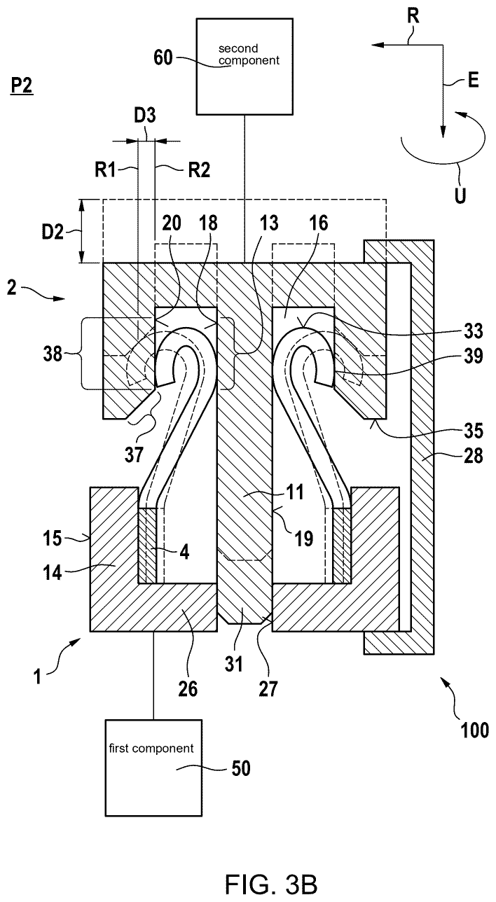

FIGS. 3A and 3B are schematic cross-sections through a plug-in connector arrangement with the mating plug-in connector in a first position (FIG. 3A) and in a second position (FIG. 3B), according to an example embodiment of the present invention.

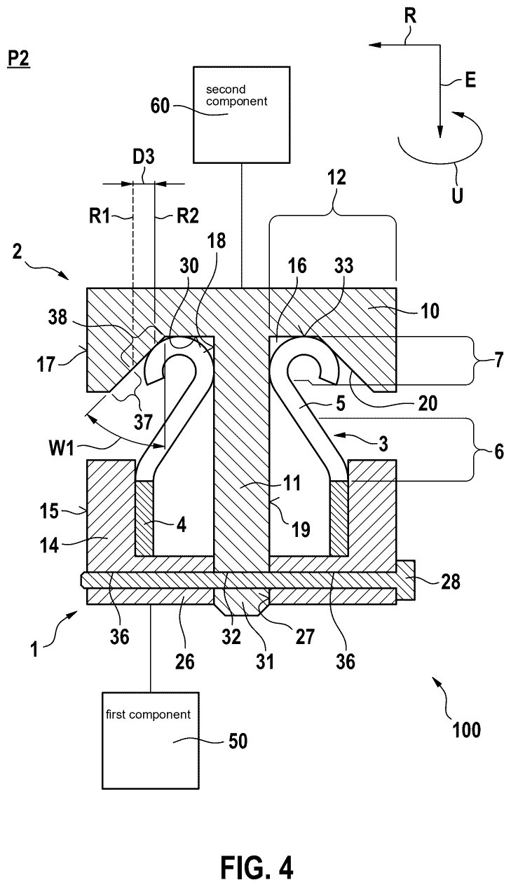

FIG. 4 are schematic cross-sections through a further plug-in connector arrangement with the mating plug-in connector in the second position, according to an example embodiment of the present invention.

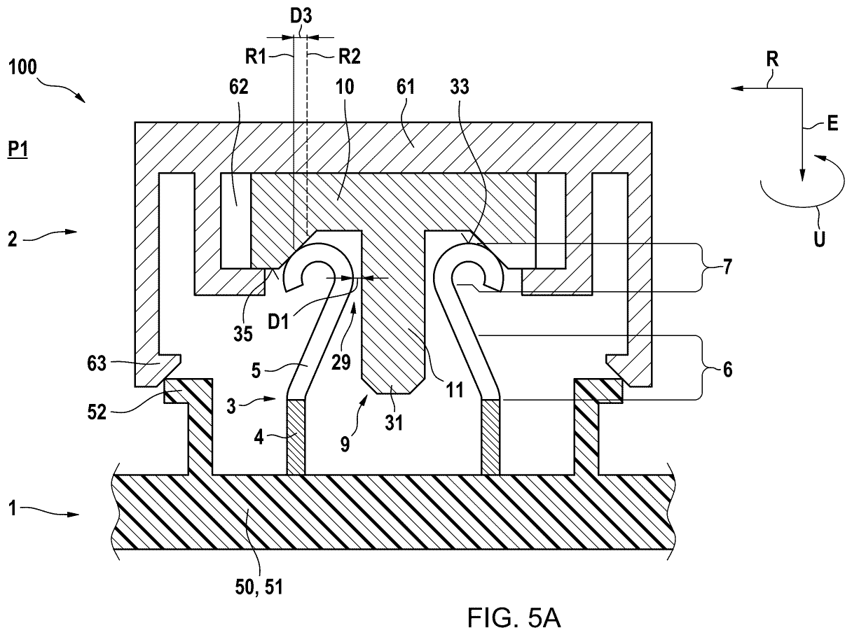

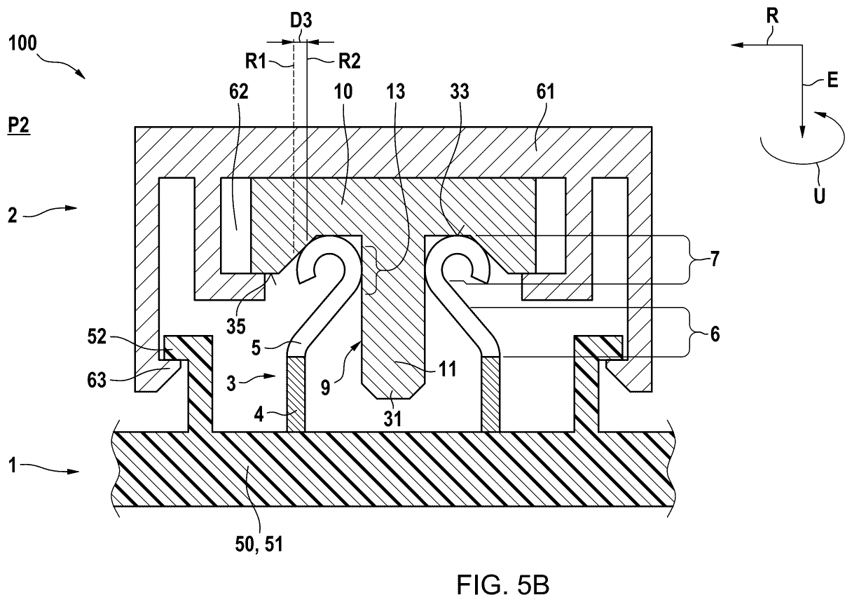

FIGS. 5A and 5B are schematic cross-sections through a further plug-in connector arrangement with the mating plug-in connector in the first position (FIG. 5A) and in the second position (FIG. 5B), according to an example embodiment of the present invention.

### DETAILED DESCRIPTION OF EXAMPLE EMBODIMENTS

FIG. 1 shows a schematic perspective view of a plug-in connector arrangement 100 in a non-contacted state, e.g., in a pre-plugged position. For reasons of clarity, neither an actuating element (such as, e.g., a lever element or a slider element) for reducing the operating force when plugged together, nor a plug-in connector housing nor a mating plug-in connector housing are shown here. Such elements are conventional and do not represent essential elements for the implementation of the present invention.

The plug-in connector arrangement 100 is configured here merely by way of example for high-current applications (e.g., for transmitting at least 10 A, preferably at least 50 A, and particularly preferably at least 100 A) and/or high-voltage applications (e.g., for at least 100 V, preferably at least 200 V, and particularly preferably at least 500 V).

The plug-in connector arrangement 100 comprises a plug-in connector 1 along with a mating plug-in connector 2 for plugging together, here, by way of example, along an insertion direction E, with the plug-in connector 1, wherein a radial direction R runs perpendicularly to the insertion direction E, and wherein a circumferential direction U runs around the insertion direction E. The insertion direction E can also be referred to as the axial direction. The plug-in connector 1 comprises a lamella cage 3 having a base element 4 and having a plurality of contact lamellae 5. The contact lamellae 5 are connected to the base element 4 in a rear portion 6. They protrude from the base element 4 in the direction of the mating plug-in connector 2, and they comprise a front portion 7 which faces the mating plug-in connector 2 and, has here, by way of example, a self-supporting end 8.

It is understood that the contact lamellae 5 can in principle be formed to be connected in their front portion to a further base element.

Here, the lamellae or contact lamellae 5 of the lamella cage 3 are, starting from the base element 4, initially bent radially inward or initially run obliquely toward the contacting part 11, in a tilted or bent or displaced manner upward (toward the free end 8). In the front portion 7, the contact lamellae 5 are then bent away from the contacting part 11 in the radial direction R, wherein, by way of example, the free end 8 of the contact lamellae 5 here forms an end face 33 facing the mating plug-in connector 2. By bending the front portion 7, an insertion funnel is provided here, by way of example, wherein the contact lamellae 5 form an angle in the range between 10° and 35° with respect to the axial direction on the end face 33.

The plug-in connector 1, by way of example, also has here a contact chamber 14 with an outer wall 15, wherein the lamella cage 3 is arranged in the contact chamber 14, wherein the base element 4 is arranged in the interior of the contact chamber 14 adjacent to the outer wall 15. The contact chamber 14 can, for example, be electrically conductive. The contact chamber 14 is arranged on or at or in a first component 50.

The lamella cage 3 can, for example, be electrically connected via its base element 4 to the first component 50. Depending on the embodiment, it can also be mechanically connected to the first component 50, e.g., by a press-fit connection and/or a soldered connection or the like.

The first component 50 can be designed, e.g., as a printed circuit board 51 or as a current collecting rail or a so-called “busbar.” It can also be directly connected to an electrical power unit, e.g., an inverter, an AC/DC converter, a battery, an electrical machine or the like, or be designed as such a power unit. Thus, a particularly simple embodiment of a plug-in connector 1 is shown here. It is understood that in other embodiments the plug-in connector 1 can also comprise a plug-in connector housing in which the lamella cage 3 is arranged.

The mating plug-in connector 2 comprises a contact element 9 having a head portion 10 and a contacting part 11. The contacting part 11 protrudes from the head portion 10, here, by way of example, along the insertion direction E. The head portion 10 has a collar 12, which projects in the radial direction R beyond the contacting part 11.

The contact element 9 is, here by way of example, electrically connected to a second component 60, e.g., directly as shown here or via a line or via a busbar, etc. The second component 60 can, e.g., be designed as a further power unit, e.g., as an inverter, an electrical machine, a battery, etc. However, the second component 60 can also be a printed circuit board or a line that is connected to the further power unit.

FIG. 1 shows in dashed lines that a groove 16 is introduced into the collar 12 on a bottom side 35 facing the lamella cage 3. The groove 16 is arranged here, by way of example, between the contacting part 11 and an edge 17 of the collar 12. On a groove outer wall 20 facing the edge 17, the groove 16 runs obliquely outward at least partially (here: from the bottom side 35 to a groove bottom 30 of the groove 16).

In a top view of the bottom side 35, the groove 16 has, by way of example, the shape of a half-funnel, in which the oblique wall is arranged radially outward. The groove 16 furthermore has a groove inner wall 18, which is flush with a contacting part outer wall 19 of the contacting part 11. The groove inner wall 18 can, for example, run in parallel with the axial direction. The groove 16 runs here, by way of example, around the contacting part 11 along the circumferential direction U. Here, by way of example, it is designed to be closed in a ring shape. Here, merely by way of example, it has a uniform cross-section.

The contact element 9 and, by way of example, at the same time also the mating plug-in connector 2 are here, in particular in the plugged-together state with the plug-in connector 1, displaceable between a first position P1 and a second position P2 (see, for example FIG. 3A, 3B, 5A, 5B), in particular along the insertion direction E. The first position P1 can be referred to, for example, as a pre-contact position or intermediate plugging position; here, the contacting part 11 can, for example, already overlap with the contact lamellae 5, for example along at least 50% or at least 70% of its longitudinal extent. The second position P2 can be referred to as the end contact position or final plugging position, in which the electrical connection is formed in the target state. A position as shown in FIG. 1 can be referred to, for example, as a pre-plugged position, in which, for example, the actual plugging process has not yet resulted in an overlap of the contact lamellae 5 and the contacting part 11 or the contacting part 11 only overlaps at its front end with the contact lamellae 5 to a very small extent (e.g., <20% or <10%).

In the first position P1 (see, for example, FIGS. 3A and 5A), the groove outer wall 20 is mechanically coupled in a first groove portion 37 to the front portion 7 of the contact lamellae 5 in an, in particular outer, first radial position R1. For example, in the first position P1, a radial play is formed between the contact lamellae 5 and the contacting part 11 of the mating plug-in connector 2.

In other words, the groove 16 catches the contact lamellae 5.

The radial play can be formed, for example, as a gap 29, wherein a first distance D1 is formed between the contact lamellae 5 and the contacting part 11 (see FIGS. 3A and 5A).

In the second position P2 (see, for example FIG. 3B, 4, 5B), the groove outer wall 20 is mechanically coupled in a second groove portion 38 to the front portion 7 of the contact lamellae 5 in an, in particular inner, second radial position R2, wherein, in the second radial position R2, the contact lamellae 5 are displaced along the radial direction R toward the contacting part 11 and thereby electrically contact the contacting part 11 in a contact portion 13 of the contacting part 11 and in particular clamp the contacting part 11 between them (in particular when viewed along the radial direction R).

The first position P1 and the second position P2 are spaced apart from each other in the axial direction or along the insertion direction E by a second distance D2 (see FIG. 3B).

The first radial position R1 can be spaced apart from the second radial position R2 by a third distance D3 in the radial direction (see FIG. 3A, 3B, 4, 5A, 5B). The third distance D3 can, for example, be at least the same size, preferably larger, than the first distance D1 (the radial play) in the first position P1. The third distance D3 can, for example, be at least 5%, preferably at least 10%, greater than the first distance D1. This results in particularly safe contacting and a particularly high contact normal force.

Starting from the first position P1, the second position P2 can be reached, for example, by applying an axial force to the contact element 9. The contact lamellae 5 are guided along the groove outer wall 20 by the mechanical coupling to the groove outer wall 20 (or by the contact with the groove outer wall 20) when the contact element 9 is displaced from the first position P1 to the second position, and are displaced at least partially in the radial direction R toward the contacting part 11 due to the slope of the groove outer wall 20. As a result, the contact lamellae 5 in the contact portion 13 are pressed against the contacting part 11 at the latest in the second position P2.

The lamella cage 3 can be made, e.g., of an electrically highly conductive material such as, e.g., copper or a copper alloy. The contact lamellae 5 can be designed to be elastically reversible with respect to the displacement of the contact element 9 from the first position P1 to the second position P2. This means that, when the contact element 9 is displaced back from the second position P2 to the first position P1 or even further, the contact lamellae are displaced back (approximately) to their initial position, which they had assumed in the force-free initial state. Subsequently, a new plugging process can take place, which, in the second position P2 of the contact element 9, again leads to a displacement of the contact lamellae 5 radially toward the contacting part 11 and to an electrical contacting of said contacting part.

The front portion 6 of the contact lamellae 5 can advantageously be caught, for example, by the groove 16 and thus be arranged in the correct radial position on or in the collar 12, e.g., already in the first position P1. If one or more contact lamellae 5 are damaged or bent, i.e., for example, if the end face 33 is not in the correct radial position, or if the contact element 9 is placed slightly radially offset, an (in particular radial) self-centering of the bent contact lamella(e) 5 in the groove 16 can then advantageously be carried out and/or a radial self-centering of the contact element 9 can be carried out. If there is a significant bending of one or more contact lamellae 5, it is possible for the contact element 9 to become tilted since some contact lamellae 5 are caught in the groove 16, but others are outside on the bottom side 35 of the collar 12. Such a misalignment can serve to indicate a problem to a technician or a machine. The assembly quality can thus be advantageously improved.

By accommodating or arranging the front portion of the contact lamellae in the groove 16, at the latest in the second position P2 (see FIG. 3A, 3B, 4, 5A, 5B), the contact lamellae 5 are advantageously protected against (radially) slipping out of the contacting position, e.g., even in the event of stronger vibration loads or alternating thermal loads. Thus, it cannot easily happen that the end face 33 is displaced radially outward for a short time (e.g., due to an impact) and that the contact lamella 5 as a result changes its bend (e.g., into a bistable second state in which the contact lamella 5 folds over radially outward at the level of the contact portion 13).

The insertion direction E can also be defined as the direction given by the displacement direction of the contact element 9 when contacting the lamella cage 3.

In FIGS. 2A and 2B, perspective schematic views of two different lamella cages 3 of a plug-in connector 1 are shown.

FIG. 2A shows a lamella cage 3, in which the contact lamellae 5, starting from the base element 4, initially run obliquely inward and upward (are radially inclined toward the contacting part 11 not shown here).

In other words, the contact lamellae 5 extend at least partially obliquely from the base element 4 toward the contacting part 11 (not shown here).

The free ends 8 of the contact lamellae 5 are bent here, by way of example, in such a way that a type of hook or a type of eyelet is formed in each case. The front portion 7 forms the end face 33 of the contact lamellae 5, which faces the contact element 9 and its collar 12 of the mating plug-in connector 2. On this end face 33, for example, the groove bottom 30 of the contact element 9 can mechanically contact the corresponding contact lamella 5 and, in addition to the slot-type guidance through the oblique groove outer wall 20, can exert an axial force on the contact lamella during the displacement from the first position P1 to the second position P2. The mechanical coupling of the contact lamellae 5 with the first and second groove portions 37, 38 (see FIG. 3A, 3B, 4, 5A, 5B) takes place, when viewed radially, further outside the end face 33 (or further away from the contacting part 11) in a coupling portion 39. The free end 8 is bent at an angle relative to the contact portion 13, which can, for example, be in a range between 150° and 230° and here is approximately 180° with respect to the insertion direction E. A lamella cage 3 shaped in this way has a particularly smooth end face 33 and a particularly smooth coupling portion 39 for coupling with the first and second groove portions 37, 38, in particular without pointed ends. The end face 33 and the coupling portion 39 thus also have a relatively large contact surface in comparison to a free end 8 forming the end face 33 or the coupling portion 39. This minimizes the risk of the end face 33 jamming on the oblique groove outer wall 20 and/or of the end face 33 digging into the groove bottom 30 when an axial force is exerted on the contact element 9, which could make it difficult to release the plug-in connector 1 and the mating plug-in connector 2. Furthermore, a front portion 7 shaped in this way with a strongly bent free end 8 can advantageously fill the groove 16 in the head portion 10 particularly well and advantageously increase the contact surface of the contact lamella 5 to the contact element 9. Finally, a free end 8 bent as in FIG. 2A advantageously simplifies transport and assembly of the lamella cage 3. This is because this minimizes the risk of different lamella cages 3, which are used, for example, as bulk material, becoming entangled with one another or of their free ends being damaged, for example, plastically bent, during transport. The end face 33 designed in this way can furthermore have the function of an insertion funnel, which ensures that the contacting part 11 can be inserted into the interior of the lamella cage 3 (into a contacting space of the lamella cage 3) particularly easily and without entanglement.

FIG. 2B shows a lamella cage 3, in which the free ends 8 of the contact lamellae 5 similarly run initially obliquely radially inward or obliquely toward the contacting part 11 (not shown here) and are then bent radially outward (away from the contacting part 11) as in the lamella cage 3 in FIG. 1. The free ends 8 or a portion or part of their sides facing the contacting part 11 (not shown) form the end face 33 here, by way of example. The lamella cage 3 shown in FIG. 2B is particularly easy to produce. The shape, which is slightly bent radially outward at the free end 8, creates a small friction surface between the groove outer wall 20 and the contact lamellae 5. Furthermore, this also advantageously prevents the free ends 8 from digging into the groove bottom 30 when an axial force is applied to the contact element 9. A sliding surface is provided, which particularly easily converts an axial force application of the groove bottom 30 into a radial movement of the contact lamellae 5 toward the contacting part 11 (here: radially inward).

In the two exemplary embodiments of FIGS. 2A and 2B, the base element 4 of the lamella cage 3 is designed, merely by way of example, to be closed circumferentially. It is designed here, by way of example, to be closed in a ring shape. The lamella cages 3 designed in this way enclose an interior 34, which can also be referred to as a contacting space. The contacting part 11 of the contact element 9 can be inserted into this interior 34. The contacting process (between the contacting part 11 and the contact lamellae 5) takes place therein.

FIG. 2C shows a top view of a stamped sheet as the initial state for a lamella cage 3, as shown, for example, in FIG. 2A or 2B. Thus, this is ultimately a two-dimensional precursor to the lamella cage 3.

In FIG. 2C on the lower side, one can see the base element 4 and the majority of the contact lamellae 5 protruding upward therefrom. On the left side of the base element 4 in FIG. 2C, two pins 25, which are round here by way of example, can be seen and are connected to the base element 4 by means of a neck region having a smaller diameter. On the right side of the base element 4 in FIG. 2C, two recesses 24 (likewise with a neck region) complementary to the pins 25 can be seen. In order to design the lamella cage 3, this two-dimensional stamping die can first be pressed or embossed, for example, in such a way that the desired course of the contact lamellae 5 is obtained (e.g., a portion initially running obliquely radially inward toward the contacting part 11 and then a front portion 7 running radially outward with a more or less strongly bent free end 8). Subsequently, the lamella cage 3 can be formed by a winding process, wherein the pins 25 are latched or inserted into the recesses 24 and the lamella cage 3 is held in a dimensionally stable manner by means of the, here form-fitting, connection of the base element 4. In other embodiments, the base element can be connected by a material bond (e.g., soldered, welded, glued, etc.). In still other embodiments, the base element can simply be wound and/or, e.g., embossed so that it automatically maintains the specified shape, e.g., is designed to be closed in a ring shape.

FIGS. 3A and 3B show schematic cross-sections through a plug-in connector arrangement 100 with the mating plug-in connector 2 in the first position P1 (FIG. 3A) or in the second position P2 (FIG. 3B). One contact lamella 5 each can be seen to the left and to the right of the contacting part 11. Furthermore, it can be seen schematically how the first component 50 is electrically connected to the plug-in connector 1 and how the second component 60 is electrically connected to the mating plug-in connector 2. In FIGS. 3A and 3B as well, for reasons of clarity, no actuating element for reducing the plug-in force is shown, even if such an actuating element (e.g., a lever element, a slider element, or the like) can be provided optionally.

The collar 12 of the contact element 9 has a groove 16 on its bottom side 35 facing the contact lamellae 5. The groove 16 here has a groove outer wall 20, which, in the first groove portion 37, runs obliquely outward to the edge 17 of the collar 12 and has a first angle W1 with respect to the insertion direction E which is different from zero. In the second groove portion 38, the groove outer wall 20 runs perpendicularly to or in parallel with the insertion direction E. It could in principle (when viewed in FIGS. 3A and 3B from bottom to top) also run radially outward and thus form an undercut or a pouch-like pocket with a narrower neck. This configuration of the groove outer wall 20 in the second groove portion 38 advantageously brings about a type of self-locking of the plug-in connector arrangement 100 in the second position P2. In other words, in the second position P2, (e.g., due to a spring-like force acting radially outward, away from the contacting part 11) the front portion 7 of the contact lamellae 5 cannot exert an axial force component on the groove outer wall 20, which would lead to a drifting apart of the plug-in connector 1 and the mating plug-in connector 2.

Furthermore, it is also possible, for example, that the bottom side 35 of the collar 12 is concavely curved, i.e., it is lower at the edge 17 than in the region of the contacting part 11 or than in the region of the beginning of the groove outer wall 20. In such a case, it can, e.g., form a continuous surface without jumps (such as, e.g., through a groove 16).

FIG. 3A shows the first position P1 when plugging together plug-in connector 1 and mating plug-in connector 2. The contacting part 11 already overlaps to a very large extent (almost 100%) with the lamella cage 3 (overlap along the insertion direction E). The first groove portion 37 of the contact element 9 rests loosely on the coupling portion 39 of the contact lamellae 5. No or only a small axial force (e.g., only the force of gravity) or radial force is exerted by the contact element 9 on the contact lamellae 5. The contact point between the contact plate 5 and the groove outer wall in the first position P1 results in the first radial position R1. The second radial position, which is only reached in the second position (see FIG. 3B), is already shown here for illustration purposes. The first, radially outer, radial position R1 and the second, radially inner, radial position R2 are spaced apart from each other by the third distance D3. The third distance D3 is here, by way of example, larger than the first distance D1.

The plug-in connector 1 has a contact chamber 14 with an outer wall 15, wherein the lamella cage 3 is arranged in the contact chamber 14, wherein the base element 4 is arranged inside the contact chamber 14 adjacent to the outer wall 15.

The contact chamber 14 also comprises here, by way of example, a bottom 26. Arranged in the bottom 26 of the contact chamber 14 is a bottom recess 27, into which here, by way of example, a front end 31 of the contacting part 11 (here: a self-supporting end of the contacting part 11) can be inserted (e.g., in the second position P2, see FIG. 3B). In this way, e.g., the correct radial positioning of the contacting part 11 in the second position P2 can be ensured or the positioning tolerances can be reduced when they are plugged together.

FIG. 3A furthermore shows that, in the first position P1, a radial play is formed between the contact lamellae 5 and the contacting part 11 of the mating plug-in connector 2, here in the form of a gap 29.

The mating plug-in connector can, for example, be displaceable from a pre-plugged position (a position of the mating plug-in connector further up than in FIG. 3A, in particular without overlap of the contacting part 11 and the contact lamellae 5 or the contact portion 13) at least up to the first position P1 of the mating plug-in connector 2 with a force of less than 5 N, in particular in a force-free manner, along the insertion direction E.

The force-free displacement or the displacement with a force of less than 5 N refers in particular to forces that are necessary to overcome frictional forces, snap forces, etc. Overcoming gravity, e.g., in the case of overhead installation, should not be taken into account here.

In the first position P1, here by way of example, the radial play between the contact lamellae 5 and the contacting part 11 is in a range between 5 um (5 micrometers) and 200 um (200 micrometers) or in a range between 20 um and 100 um, e.g., at 20 um or at 30 um or at 40 um or at 50 um or at 60 um or at 70 um or at 80 um or at 90 um or at 100 um or at 130 um or at 160 um or at 200 um. In other words, the gap 29 effects the radial play and establishes a first distance D1 (in radial direction R) in the range described above (e.g., between 5 um and 200 um, etc.).

It is clearly visible that, in this exemplary embodiment, the contact lamellae 5 in the front portion 6 are bent in the radial direction R away from the contacting part 11. Here by way of example, they are bent relative to the insertion direction E by a second angle W2, which is here, by way of example, somewhat larger than 180° and can be, merely by way of example, in a range between 185° and 260°. In other exemplary embodiments the second angle W2 can also be omitted entirely, or it can, e.g., be at least 30°, preferably at least 60° and particularly preferably at least 110°.

FIG. 3A furthermore shows that the contact lamellae 5 here, by way of example, in their rear portion 6, starting from the base element 4, run obliquely inward or obliquely toward the contacting part 11. A third angle W3 between the contact lamella 5 and the insertion direction E can, for example, be between 5° and 40°, preferably between 10° and 35°.

FIG. 3B shows the contact element 9 in the second position P2 (solid lines—the previous first position P1 from FIG. 3A is shown with dashed lines). The front end 31 of the contacting part 11 is inserted into the bottom recess 27 of the bottom 26 of the contact chamber 14 or is arranged in the bottom recess 27. For this purpose, the bottom recess 27 can, e.g., comprise an, in particular slightly, oversized dimension (e.g., up to 500 um, preferably up to 250 um) compared to the front end 31. However, a press fit can also be formed, i.e., the front end 31 comprises an, in particular slightly, oversized dimension with respect to the diameter of the bottom recess 27. In this way, the contact element 9 is guided and/or secured in the radial direction 9, as a result of which a permanent and reliable contacting is advantageously ensured even under adverse operating conditions (e.g., vibration loads, thermal cycling loads, etc.).

The first position P1 and the second position P2 are here, by way of example, spaced apart along the insertion direction E by a maximum of 5 mm, preferably by a maximum of 2 mm, and particularly preferably by a maximum of 1 mm. This axial spacing is represented by the second distance D2.

In other words, the second position P2 is spaced apart from the first position P1 by a second distance D2 (viewed along the insertion direction E).

In the second position P2, the groove outer wall 20 is mechanically coupled in a second groove portion 38 (here: the perpendicular part of the groove outer wall 20) to the front portion 7 of the contact lamellae 5 in the, in particular inner, second radial position R2, wherein, in the second radial position R2, the contact lamellae 5 are displaced along the radial direction R toward the contacting part 11 and thereby electrically contact the contacting part 11 in a contact portion 13 of the contacting part 11 and in particular clamp the contacting part 11 between them (in particular when viewed along the radial direction R).

In other words, the oblique groove outer wall 20 has pressed on the coupling portion 39 with a radial force component on the (axial) path from the first position P1 to the second position P2 in the manner of a slot guide and thereby forced the contact lamellae 5 to deflect radially inward or toward the contacting part 11 in the radial direction R or tilted them or displaced them. As a result, the contacting part 11 in the contact portion 13 is subjected by means of the contact lamellae 5 to a contact normal force that here, by way of example, acts substantially in the radial direction R.

In this embodiment, by way of example, in the second position P2 the contact lamellae 5 contact the contact portion 13 with a contact normal force in the radial direction R of at least 1 N, preferably of at least 5 N.

In addition to the contacting between the plug-in connector 1 and the mating plug-in connector 2 by means of the contact lamellae 5 in the contact portion 13 of the contacting part 11, further current-conducting paths are formed, which run via the coupling portion 39 in the front portion 7 of the contact lamellae 5 to the groove outer wall 20. These contacting points run here, by way of example, radially outward, i.e., in the opposite direction to the contacting points in the contact portion 13 of the contacting part 11.

This results in particularly reliable and safe contacting. This is because, on the one hand, the number of contact points is significantly increased (here: doubled). On the other hand, due to the contact points or contacting points substantially pointing away from one another, contacting is provided that is particularly robust against mechanical influences from different directions (e.g., vibrations or alternating thermal stresses) and against manufacturing tolerances.

FIG. 3B furthermore shows that the base element 4 is supported on the outer wall 15 of the contact chamber 14 in the second position P2. This support is provided here, by way of example, substantially along the radial direction R. Due to the radial outward pressure exerted by the elasticity of the contact lamellae 5, the contact lamellae 5 can press, tilt, or displace the base element 4 radially outward. This displacement is limited by the support on the outer wall 15, on which the base element 15 is supported. This stabilizes the lamella cage 3. The contact normal force of the contact lamellae 5 on the contact portion 13 can thus be maintained or set in a defined manner.

Merely schematically, an optional locking element 28 is furthermore shown, which secures the second position P2 against releasing. The locking element 28 is designed here, merely symbolically or schematically, as a clamp, which clamps the contact element 9 and the contact chamber 14 together and thus secures the plug-in connector 1 and the mating plug-in connector 2 against being displaced away from each other.

FIG. 4 shows a schematic cross-section through a further plug-in connector arrangement 100 in the second position P2, wherein this plug-in connector arrangement 100 is designed similarly to that of FIG. 1 or 3B.

The plug-in connector arrangement 100 of FIG. 4, however, inter alia differs from that of FIG. 3B in that the groove outer wall 20 here has a continuous, linear slope. The first groove portion 36 and the second groove portion 37 thus have the same gradient. This makes groove 16 particularly easy to produce.

Furthermore, the plug-in connector arrangement 100 of FIG. 4 differs from that of FIG. 3B in that, in the second position P2, the groove bottom 30 mechanically contacts the front portion 7 of the contact lamellae 5 in such a way that the contact lamellae 5 are displaced along the radial direction R toward the contacting part 11 and, as a result, the contact lamellae 5 exert an additional contact normal force in the radial direction on the contact portion 13 of the contacting part 11.

In this way, the slot guide through the groove outer wall 20 and the resulting radial displacement of the contact lamellae 5 is additionally supported by an axial compression of the contact lamellae 5. By contacting the groove bottom 30 with the end faces 33 of the contact lamellae 5, the number of contact points and the contact surface are further increased. Furthermore, these current paths are formed along the axial direction, which further increases the robustness of the contacting against, for example, mechanical or thermal loads from different directions and also against manufacturing tolerances.

In this exemplary embodiment, the groove inner wall 18 is flush with a contacting part outer wall 19. As a result, the contact lamellae 5 can be particularly close to the contacting part 11, and a high contact normal force in the contact portion 13 can be achieved particularly easily.

In this exemplary embodiment, the contact lamellae 5 contact the groove 16 on at least two sides. The at least two sides are preferably spaced apart from each other by at least 30° (this is understood to mean an angle in the illustrated image plane, not an angle along the circumferential direction U). One contact side here is, by way of example, the groove inner wall 18 (this contact point can be spaced apart in the axial direction from the contact portion 13). A further contact side is, here by way of example, the groove bottom 30. In this exemplary embodiment, the groove outer wall 20 is furthermore contacted by the contact lamella 5. The front portion 6 of the contact lamellae 5 is pressed together in the groove 16 due to the axial force applied by the contact element 9 in the second position P2 and fills the groove 16 in the second position P2 to a significantly greater extent than in the first position P1. In this way, the contact surface between contact lamellae 5 and contact element 9 is considerably enlarged, as a result of which the current carrying capacity of the plug-in connector arrangement 100 (significantly) increases and contact resistance decreases. Furthermore, the number of contact points is advantageously increased. This advantageously increases the redundancy at contact points, so that the plug-in connector arrangement 100 is better protected against failures.

The optional locking element 28 for securing the second position P2 is shown here, merely by way of example, as a slider, which, in the second position P2, can be guided through locking recesses 36 in the bottom 26 of the contact chamber 14 and, in the region of the bottom recess 27, engages through a recess 32 in the contacting part 11.

In this exemplary embodiment, it is provided that the first angle W1 of the groove outer wall 20 with respect to the insertion direction E is in a range between 2° and 45° (i.e., a range of 2° to 45°) or in a range between 3° and 15° (i.e., a range of 3° to 15°). The first angle W1 can also be in this range in the other exemplary embodiments, e.g., at least in the first groove portion 37.

As a result, when the contact element 9 is displaced from the first position P1 to the second position P2 (i.e., by a distance corresponding to the second distance D2, see FIGS. 3A and 3B), in addition to the axial force application, it is ensured that the contact lamellae 5 move by a defined distance in the radial direction R toward the contacting part 11 and that, as a result, the desired contact normal force in the contact portion 13 is applied by the contact lamellae 5. Furthermore, it is ensured that a gap 29 (see FIG. 3A), which is optionally present in the first position P1, between the contact lamellae 5 and the contacting part 11 is closed.

FIGS. 5A and 5B show schematic cross-sections through a further plug-in connector arrangement 100 with the mating plug-in connector 2 in the first position P1 (FIG. 5A) or in the second position P2 (FIG. 5B).

In this embodiment, the lamella cage 3 is directly connected to the first component 50; a separate contact chamber 14 is not provided here, but could optionally be present.

The contact element 9 is received or arranged in a mating plug-in connector housing 61. It is mounted or arranged, here by way of example, at its head portion 10 in a contact element chamber 62 and is preferably secured with respect to the axial direction.

The groove 16 is similar in its cross-section to that in FIG. 4. The collar 12 projects radially outward beyond the groove 16 in order to be received, arranged, or attached in a form-fitting manner in the contact element chamber 62.

In the cross-section shown, two locking elements 52 spaced apart from each other can be seen, which are arranged on the first component 50 and protrude from the first component 50 in the direction of the mating plug-in connector 2. The lamella cage 3 is arranged between them. The locking elements 52 comprise, here by way of example, undercuts.

In the cross-section shown, two mating locking elements 63 can be seen on the mating plug-in connector housing 61, which protrude from the mating plug-in connector housing 61 in the direction of the plug-in connector 1 and each comprise a hook element. The mating locking elements 63 can be designed in the manner of (particularly along the radial direction R) elastically reversible locking lances or clip elements. The contact element 9 is arranged between the mating locking elements 63.

In the first position P1 shown in FIG. 5A, the mating locking elements 63 can, for example, rest on the locking elements 52 and thus, e.g., advantageously provide a technician with haptic feedback for reaching the first position P1. In other embodiments, it can be provided, e.g., that a captive connection between plug-in connector 1 and mating plug-in connector 2 is formed already when (or even before) the first position P1 is reached, so that the ensemble can be transported in this state.

The mating locking elements 63 can, here by way of example, slide past the undercuts of the locking elements 52 on the path from the first position P1 to the second position P2 (deflection radially outward in the exemplary embodiment shown) and can be elastically reversibly sprung back into their initial position radially inward in the second position P2, so that they engage behind the undercuts of the locking elements 52 with their hook elements. In this way, an unintentional release of the contact element 9 from the second position P2 in the direction of the first position P1 is prevented. The locking elements 52 and the mating locking elements 63 thus form a type of locking element 28.

The lamella cage 3 is designed here, by way of example, analogously to the lamella cage of FIG. 2B.

In the first position P1 (FIG. 5A), the contact element 9 has, by way of example, a radial play with respect to the contact lamellae 5; here, by way of example, a gap 29 is formed between the contacting part 11 and at least one contact lamella 5. In the second position P2 (FIG. 5B), the contact lamellae 5 are not only coupled to or mechanically and electrically contacted with the second groove portion 38 in the coupling portion 39, but the contact lamellae 5 are also in (mechanical) contact with the groove bottom 30 at or in their front portion 7. They are compressed by the axial force application of the collar 12 or the groove bottom 30 (between the collar 12 or the groove bottom 30 and the base element 4) and, as a result, are displaced in the radial direction R toward the contacting part 11, which they electrically contact in the contact portion 13 and in particular subject to a defined contact normal force. They can clamp the contacting part 11 between them, for example.

1-15. (canceled)

16. A plug-in connector arrangement for high-current applications and/or high-voltage applications, the plug-in connector arrangement comprising:
a plug-in connector;
a mating plug-in connector configured to plug together with the plug-in connector;
wherein the plug-in connector includes a lamella cage having a base element and a plurality of contact lamellae, wherein the contact lamellae are connected to the base element in a rear portion, protrude from the base element in a direction of the mating plug-in connector, and have a front portion facing the mating plug-in connector, wherein the mating plug-in connector includes a contact element having a head portion and a contacting part, wherein the contacting part protrudes from the head portion, wherein the head portion has a collar, which projects beyond the contacting part in a radial direction, wherein a groove is introduced into the collar on a bottom side facing the lamella cage, wherein the groove runs at least partially obliquely outward on a groove outer wall facing an edge of the collar,
wherein the contact element and/or the mating plug-in connector, when plugged together with the plug-in connector, can be displaced between a first position and a second position, along an insertion direction,
wherein, in the first position, the groove outer wall is mechanically coupled in a first groove portion to the front portion of the contact lamellae in a first radial position, and a radial play is formed between the contact lamellae and the contacting part of the mating plug-in connector,
wherein, in the second position, the groove outer wall is mechanically coupled in a second groove portion to the front portion of the contact lamellae in a second radial position, wherein, in the second radial position, the contact lamellae are displaced along the radial direction toward the contacting part electrically contacting the contacting part in a contact portion of the contacting part, and clamp the contacting part between them.

17. The plug-in connector arrangement according to claim 16, wherein in the second position, the contact lamellae contact the contact portion with a contact normal force in the radial direction of at least 1 N.

18. The plug-in connector arrangement according to claim 16, wherein the base element of the lamella cage is circumferentially closed in a ring shape.

19. The plug-in connector arrangement according to claim 16, wherein the first position and the second position are spaced apart along the insertion direction by at most 5 mm.

20. The plug-in connector arrangement according to claim 16, wherein, in the first position, the radial play between the contact lamellae and the contacting part is in a range between 5 um and 200 um.

21. The plug-in connector arrangement according to claim 16, wherein the contact lamellae extend at least partially obliquely from the base element toward the contacting part.

22. The plug-in connector arrangement according to claim 16, wherein:
the plug-in connector includes a contact chamber having an outer wall,
the lamella cage is arranged in the contact chamber, and
the base element is arranged inside the contact chamber adjacent to the outer wall.

23. The plug-in connector arrangement according to claim 22, wherein the base element is supported in the second position on the outer wall of the contact chamber in the radial direction.

24. The plug-in connector arrangement according to claim 16, wherein a groove inner wall is flush with a contacting part outer wall.

25. The plug-in connector arrangement according to claim 24, wherein a first angle of the groove outer wall with respect to the insertion direction is in a range between 2° and 45° or in a range between 3° and 15°.

26. The plug-in connector arrangement according to claim 16, wherein the contact lamellae contact the groove on at least two sides in each case.

27. The plug-in connector arrangement according to claim 16, wherein the contact lamellae in the front portion are bent in the radial direction away from the contacting part, relative to the insertion direction, by a second angle of at least 30°.

28. The plug-in connector arrangement according to claim 16, wherein the mating plug-in connector can be displaced from a pre-plugged position, in which the contacting part does not yet overlap with the contact lamella, at least up to the first position with a force of less than 5 N, along the insertion direction.

29. The plug-in connector arrangement according to claim 16, wherein, in the second position, a groove bottom mechanically contacts the front portion of the contact lamellae in such a way that the contact lamellae are displaced along the radial direction toward the contacting part, and the contact lamellae exert an additional contact normal force in the radial direction on the contact portion of the contacting part.

30. A mating plug-in connector for high-current applications and/or high-voltage applications, for plugging together with a plug-in connector having a lamella cage with a plurality of contact lamellae, comprising:
a contact element having a head portion and a contacting part, wherein the contacting part protrudes from the head portion;
wherein the head portion has a collar, which projects beyond the contacting part in a radial direction,
wherein a groove is introduced into the collar on a bottom side facing the lamella cage,
wherein the groove runs at least partially obliquely outward on a groove outer wall facing an edge of the collar,
wherein the contact element and/or the mating plug-in connector, in a plugged-together state with the plug-in connector, can be displaced between a first position and a second position, along an insertion direction,
wherein the groove outer wall is configured to mechanically couple in the first position in a first groove portion to a front portion of the contact lamellae in a first radial position,
wherein the groove outer wall is configured to mechanically couple in the second position in a second groove portion to the front portion of the contact lamellae in a second radial position,
wherein, in the second radial position, the contact lamellae are displaced along the radial direction toward the contacting part and electrically contact the contacting part in a contact portion of the contacting part, and, clamp the contacting part (11) between them.
